(19) United States
(12) Patent Application Publication
(10) Pub. No.: US 2025/0173940 A1
(43) Pub. Date: May 29, 2025

(54) VIDEO IMAGE PROCESSING METHOD AND APPARATUS, AND ELECTRONIC DEVICE AND STORAGE MEDIUM

(71) Applicant: Beijing Zitiao Network Technology Co., Ltd., Beijing (CN)

(72) Inventor: Yixin CHEN, Beijing (CN)

(21) Appl. No.: 18/837,575

(22) PCT Filed: Feb. 7, 2023
(86) PCT No.: PCT/CN2023/074741

§ 371 Date: Aug. 9, 2024

(30) Foreign Application Priority Data
Feb. 10, 2022 (CN) 202210126493.8

(51) Int. Cl. G06T 13/40; G06T 7/11; G06T 7/246; G06T 7/73; G06T 19/00; G06T 19/20; G06V 10/70

(52) U.S. Cl. CPC G06T 13/40; G06T 7/11; G06T 7/246; G06T 7/73; G06T 19/006; G06T 19/20; G06V 10/70; G06T 2207/30201; G06T 2219/2016; G06V 2201/07

(57) ABSTRACT

A video image processing method and apparatus, an electronic device, and a storage medium are provided. The method includes: in response to an effect triggering operation, acquiring a current image to be processed comprising a target object, and determining event information of the target object; determining part parameters of at least one model part in a target animation model according to body part information of the target object in the current image to be processed; determining target effect display parameters of the target animation model based on the part parameters and the event information; and fusing a target face image of the target object into the target animation model and determining a target video frame corresponding to the current image to be processed and playing the target video frame based on the target effect display parameters.

The application claims priority from Chinese Patent Application No. 202210126493.8 filed in Chinese Patent Office on Feb. 10, 2022, the entire contents of which are incorporated by reference in this application.

### TECHNICAL FIELD

The present disclosure relates to the technical field of image processing, for example, a video image processing method and apparatus, an electronic device and storage medium.

### BACKGROUND

With the development of network technology, more and more application programs have entered users' lives, especially a series of software that may shoot short videos, which are deeply loved by users.

In order to improve the interest of video shooting, software developers may develop a variety of effect props. However, the number of effect props developed is very limited, and the richness of video content needs to be improved, especially when displaying multiple views, the result presented by related effect have certain limitations.

### SUMMARY

The present disclosure provides a video image processing method, an apparatus, an electronic device and storage medium, so as to implement superimposing and simultaneously playing various animation effects.

The embodiments of the present disclosure provide a video image processing method, including:
in response to an effect triggering operation, acquiring a current image to be processed including a target object, and determining event information of the target object;
determining part parameters of at least one model part in a target animation model according to body part information of the target object in the current image to be processed;
determining target effect display parameters of the target animation model based on the part parameters and the event information;
fusing a target face image of the target object into the target animation model and determining a target video frame corresponding to the current image to be processed and playing the target video frame based on the target effect display parameters.

The embodiments of the present disclosure also provide a video image processing apparatus, including:
an image to be processed acquisition module, configured to acquire a current image to be processed including a target object in response to an effect triggering operation, and determine event information of the target object;
a part parameter determining module, configured to determine part parameters of at least one model part in the target animation model according to body part information of the target object in the current image to be processed;
a target effect display parameter determining module configured to determine target effect display parameters of the target animation model based on the part parameters and the event information;
a target video frame determining module, configured to fuse a target face image of the target object into the target animation model, and determine a target video frame corresponding to the current image to be processed and play the target video frame based on the target effect display parameters.

Embodiments of the present disclosure also provide an electronic device, including:
one or more processors;
a storage apparatus, configured to store one or more programs,
when the one or more programs are executed by the one or more processors, the one or more processors are caused to implement the video image processing method as any one of embodiments of the present disclosure.

Embodiments of the present disclosure also provide a storage medium containing computer-executable instructions. When the computer-executable instructions are executed by a computer processor, the computer-executable instructions perform the video image processing method as any one of the embodiments of the present disclosure.

### BRIEF DESCRIPTION OF DRAWINGS

FIG. 1 is a flowchart of a video image processing method provided by Embodiment 1 of the present disclosure;

FIG. 2 is a schematic diagram of a target animation model provided by Embodiment 1 of the present disclosure;

FIG. 3 is a flowchart of a video image processing method provided by Embodiment 2 of the present disclosure;

FIG. 4 is a flowchart of a video image processing method provided by Embodiment 3 of the present disclosure;

FIG. 5 is a flowchart of a video image processing method provided by Embodiment 4 of the present disclosure;

FIG. 6 is a schematic diagram of the display result of the target video frame provided by the Embodiment 4 of the present disclosure;

FIG. 7 is a flowchart of a video image processing method provided by Embodiment 5 of the present disclosure;

FIG. 8 is a flowchart of a video image processing method provided by Embodiment 6 of the present disclosure;

FIG. 9 is a flowchart of a video image processing method provided by Embodiment 7 of the present disclosure;

FIG. 10 is a schematic structural diagram of a video image processing apparatus provided by Embodiment 8 of the present disclosure; and

FIG. 11 is a schematic structural diagram of an electronic device provided by Embodiment 9 of the present disclosure.

### DETAILED DESCRIPTION

Embodiments of the present disclosure are described in more detail below with reference to the drawings. Although certain embodiments of the present disclosure are shown in the drawings, the present disclosure may be achieved in various forms and should not be construed as being limited to the embodiments described here. On the contrary, these embodiments are provided to understand the present disclosure more clearly and completely. The drawings and the embodiments of the present disclosure are only for exemplary purposes and are not intended to limit the scope of protection of the present disclosure.

Various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

Concepts such as “first” and “second” mentioned in the present disclosure are only used to distinguish different apparatuses, modules or units, and are not intended to limit orders or interdependence relationships of functions performed by these apparatuses, modules or units. Modifications of “one” and “more” mentioned in the present disclosure are schematic rather than restrictive, and unless otherwise explicitly stated in the context, it should be understood as “one or more”.

Before introducing the present technical solution, the application scene may be illustrated firstly. The technical solution of the present disclosure may be applied to any scene required to effect display or effect processing, for example, being applied in the process of video shooting, the shot object may be subject to effect processing to obtain a displayed target effect image; it may also be applied in the process of still image shooting, for example, after the image is shot by the camera provided by the terminal device, the shot image is processed to an effect image for effect display. In this embodiment, the added effect may be jumping, making faces and turning around and so on. In the embodiment, the target object may be a user, or a variety of shot animals.

### Embodiment 1

FIG. 1 is a flowchart diagram of a video image processing method provided by the Embodiment 1 of the present disclosure. The embodiment of the present disclosure is suitable for realizing superimposing and simultaneously playing various animation effects in any effect display or effect processing scene supported by the Internet. The method may be executed by a video image processing apparatus, which may be implemented in the form of software and/or hardware, optionally, by an electronic device, which may be a mobile terminal or a Personal Computer (PC) terminal or a server, and so on.

As illustrated in FIG. 1, the method includes the following steps.

S110: in response to an effect triggering operation, acquiring the current image to be processed including the target object, and determining the event information of the target object.

A variety of applicable scenes have been briefly described above and will not be described here. The apparatus for executing the video image processing method provided by the embodiment of the present disclosure may be integrated in an application software supporting the video image processing function, and the software may be installed in an electronic device, optionally, the electronic device may be a mobile terminal or a PC terminal, and so on. The application software may be a type of software for image/video processing, and the application software will not be detailed here, provided that it may implement image/video processing. The application software may also be a specially developed application program to implement adding effect and effect display, or it may be integrated in the corresponding pages, and the user may implement the adding effect by the pages integrated in the PC terminal.

The current image to be processed may be an image required to be processed at the current moment. The image may be an image collected based on the terminal device. Terminal device may refer to an electronic product with image shooting function, such as a camera, a smart phone and a tablet computer. In practical application, when the user triggers the effect triggering operation, the terminal device may face the user to implement colleting the image to be processed. When the target object is detected to appear in the view field of the terminal device, the video frame image in the current terminal device may be collected, and the collected video frame image is used as a current image to be processed; in the process of acquiring image, when the target object is detected as not appear in the view field of the terminal device, the video frame image of the current terminal device does not encompass the target object, the video frame image may not be acquired. Accordingly, the target object may be an object which posture or position information may be changed in the shot picture, such as a user or an animal.

When the current image to be processed is acquired, the video frame corresponding to the shot video may be processed. For example, the target object corresponding to the shot video may be preset, and when it is detected that the image corresponding to the video frame includes the target object, the image corresponding to the video frame may be used as the current image to be processed, so that the image of each of the video frames in the video may be tracked subsequently, and the image of the video frame may be subject to effect processing.

The number of target objects in a same shooting scene may be one or more, no matter one or more, the technical solution provided by the present disclosure may be adopted to determine the effect display video image.

In practical application, usually, upon some effect triggering operations being triggered, the image to be processed including the target object is collected. Then, the effect triggering operations may include at least one of the following: triggering the effect prop corresponding to the target virtual object model; including a face image in the detected view field region.

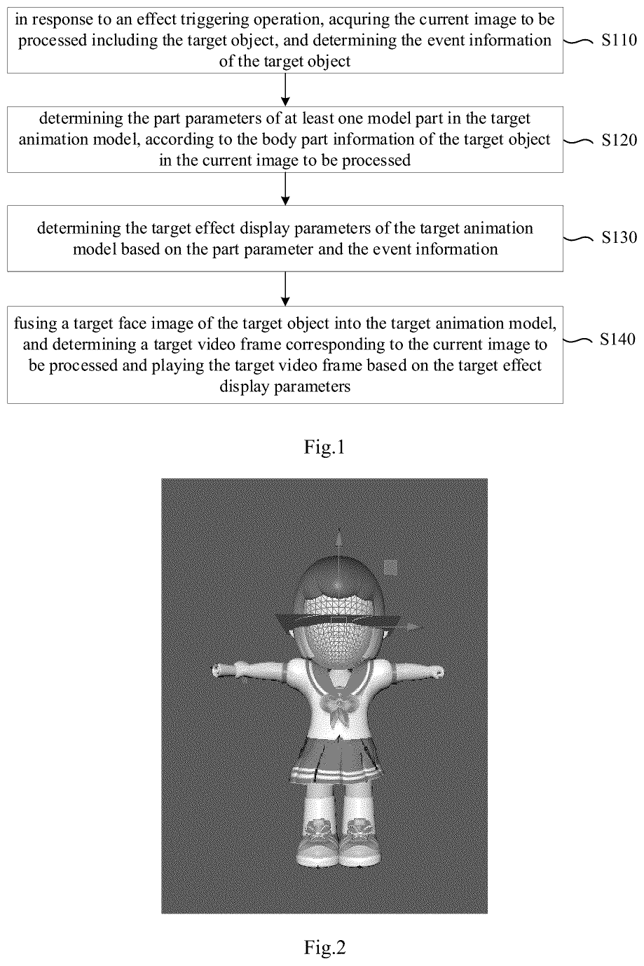

The target animation model may be understood as an effect model finally displayed on the display interface of the terminal device and may also be understood as a preset cartoon character model. The schematic diagram of the target animation model may be illustrated in FIG. 2. Optionally, the target animation model may also be an animation character model with copyright, etc., or a variety of pet models, etc. FIG. 2 is only a schematic diagram and does not limit the target animation model. The basic animation effect may be preset for each target animation model, and the setting of the basic animation effect for each target animation model may change according to the different animation scenes where the target animation model is located. For example, when the animation scene is a playground, the basic effect may be running, and then the target animation model may be a cartoon character model which is running. A control for triggering the effect prop may be preset. When the user triggers the control, an effect prop display page may pop up on the display interface, and a plurality of effect props may be displayed in the display page. The user may trigger the effect prop corresponding to the target animation. If the effect prop corresponding to the target virtual animation model is triggered, it may mean that the effect triggering operation is triggered. Another implementation may be that the shooting apparatus of the terminal device will have a certain shooting view field. When it is detected that the view field encompasses the face image of the target object, it may mean that the effect triggering operation is triggered. For example, a user may be preset as the target object, and when it is detected that the view field region encompasses the face image of the user, it may be determined that the effect triggering operation is triggered; or, the face image of the target object may be pre-stored in the terminal device, and when it is detected that one or more face images appear(s) in the view field region, if it is detected that one or more face images include(s) the face image of the preset target object, it may be determined that the effect triggering operation is triggered, so that the terminal device may track the face image of the target object and acquiring the current image to be processed including the target object.

After acquiring the current image to be processed including the target object, the event information of the target object in the current image to be processed may be determined. Event information may be understood as some action information done by the target object in the image to be processed. For example, when the target objects in the image to be processed are objects with no position change or relative displacement, the event information corresponding to the target objects may include blinking, opening mouth and moving eyebrows; or, when the target object in the image to be processed has certain motion information, that is, the position information of the target object changes, and the event information corresponding to the target object may be waving, etc., which is not limited by the embodiment of the present disclosure.

S120: determining the part parameters of at least one model part in the target animation model, according to the body part information of the target object in the current image to be processed.

The body part information of the target object may include head information and limb and trunk information.

Generally, if the current image to be processed includes a target object, there may be a certain rotation angle between the target object and the camera of the terminal device. In order to make the target animation model be more adaptive to the target object, it is necessary to determine the part parameters of at least one model part in the target animation model according to the position change of the body part of the target object in the current image to be processed. The at least one model part may be all the model parts in the target animation model, for example, it may be a plurality of key points of the head and the limb and trunk. The part parameters may be understood as parameter information used to determine the movement of model parts. For example, the part parameters may include position rotation angle information, relative position information, etc. The embodiment of the present disclosure does not limit the model position and part parameters.

In the embodiment, after acquiring the current image to be processed including the target object, the model parameters of at least one model part in the target animation model on the shooting interface of the terminal device are determined according to the body part information of the target object in the acquired current image to be processed, so that the movement of the at least one corresponding model part may be determined according to the model parameters.

S130: determining the target effect display parameters of the target animation model based on the part parameters and the event information.

In this embodiment, the target animation model will have corresponding basic animation effect according to the different animation scenes, so the target effect display parameters may be understood as an animation scene parameter and an effect superimposed parameter determined based on event information. Optionally, the target effect display parameters may include the current limb parameter, the part parameter and the animation effect parameter to be fused corresponding to the event information of each limb and trunk model in the target animation model. Among them, the current limb parameter may be understood as multiple parameters used to represent the limb movement of the target animation model at the current moment. For example, the current limb parameter may include the limb movement direction, the limb movement distance, the limb rotation angle, the limb movement amplitude information and the like. For example, when the animation scene where the target animation model is located is a playground, the basic animation effect of the target animation model is running, when the target animation model moves based on the basic animation effect, the leg model part of the target animation model may be running, and the hand and arm model parts may be in state of swinging back and forth. When the event information of the target object in the image to be processed is detected as waving, it means the superimposed animation effect corresponding to the event information is triggered. At this time, the target animation model will move based on the basic animation effect and the superimposed animation effect, and the hand model part of the target animation model will change from the swinging state to the waving state. Then, in the current video frame, the target effect display parameters are the model part parameter of the target animation model and the superimposed animation effect parameter based on the event information.

The superimposed effect corresponding to the event information may be one or more and so on. No matter one or more, the technical solution provided by the present disclosure may be adopted to determine the target effect display parameter.

In the embodiment, after determining the event information of the target object and the part parameter of the at least one model part in the target animation model, the superimposed effect parameter of the target animation model may be preliminarily determined according to the determined part parameter and event information, wherein the superimposed effect parameter may be the parameter information such as the effect action and action amplitude of the target animation model; for example, according to the superimposed effect parameter and the basic effect parameter of the target animation model, the target effect display parameters may be finally determined, so that the target animation model may display corresponding target effect according to the determined target effect display parameters.

S140: fusing a target face image of the target object into the target animation model and determining a target video frame corresponding to the current image to be processed and playing the target video frame based on the target effect display parameters.

In this embodiment, after acquiring the current image to be processed including the target object, the target face image of the target object may be acquired, and the target face image of the target object may be fused into the target animation model, so that the target object and the target animation model may be adapted to each other.

For example, based on the determined target effect display parameters, the target animation model may be made to perform operations corresponding to the target effect display parameters, and the video frame image currently determined based on the target effect display parameters may be used as the target video frame. For example, the target video frame may include the basic effect of the target animation model and the superimposed effect corresponding to the event information of the target object, etc. For example, when the target effect display parameters are multiple parameters in the above example, the target video frame of the target effect display parameters displays the head model of the target animation model as the face image of the target object, and the leg model as the running state; if the event information is waving, the hand of the target animation model may be waving; if there is no corresponding event information, the hand of the target animation model may be the state of swing back and forth.

According to the technical solution of the embodiments of the present disclosure, by responding to the effect triggering operation, the current image to be processed including the target object is acquired and the event information of the target object is determined; the part parameters of the at least one model part in the target animation model are determined according to the body part information of the target object in the current image to be processed; and the target effect display parameters of the target animation model are determined based on the part parameters and the event information, the target face image of the target object is fused into the target animation model, and the target video frame corresponding to the current image to be processed is determined and played based on the target effect display parameters, which enriches the prop for effect display. When the user uses the effect prop corresponding to the target animation model, the effect may be superimposed on the basis of the original effect, and a plurality of superimposed animation effects may be played at the same time, which not only improves the richness and interest of video content, but also improves the playing result of animation effects.

### Embodiment 2

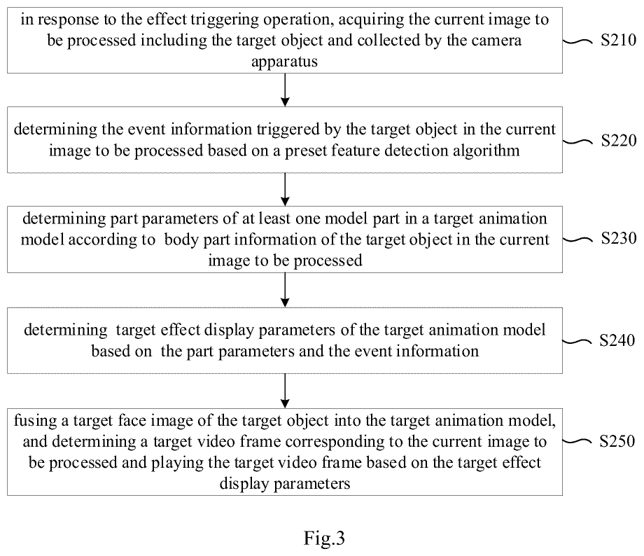

FIG. 3 is a flow chart of a video image processing method provided by Embodiment 2 of the present disclosure. On the basis of the aforementioned embodiment, S110 is described, and the implementation may refer to the technical solution of the embodiment. Among them, technical terms that are the same as or corresponding to the above embodiments are not repeated here.

As shown in FIG. 3, the method includes the following steps.

S210. in response to the effect triggering operation, acquiring the current image to be processed including the target object and collected by the camera apparatus.

For example, the camera apparatus may be a built-in camera of the terminal device, such as a front camera or a rear camera, an external camera of the terminal device, such as a rotating camera, or other camera apparatuses for implementing the image acquisition function, which is not limited in this embodiment.

Optionally, based on the image to be processed collected by the camera apparatus, a camera apparatus enable instruction may be input by an input device such as a touch screen or a physical button in the terminal device, to control the camera apparatus on the terminal device to be in a video image shooting mode and collect the image to be processed; or, a camera enable control may be preset in the terminal device, and when it is detected that the control is triggered by the user, the camera corresponding to the control may be enabled and the image to be processed may be collected; or, the video image shooting mode of the camera apparatus may also be enabled in other ways, so as to implement the function of collecting the image to be processed, which is not limited by the embodiment of the present disclosure.

In the embodiment, when it is detected that the user triggers the effect triggering operation, the corresponding effect triggering operation may be responded, and the current image to be processed including the target object may be collected by the camera apparatus of the terminal device, so that the collected image to be processed may be subjected to subsequent operations.

S220: determining the event information triggered by the target object in the current image to be processed based on a preset feature detection algorithm.

The event information is matched with the limb movement information of a plurality of preset detection parts, that is, when the target object triggers an event information, the event information needs the mutual cooperation of a plurality of parts of the target object, and correspondingly, the event information includes the limb movement information of a plurality of preset detection parts in the target object, such as triggering the corresponding event information by the mutual cooperation of the head, the hand, the shoulder and the leg.

The preset feature detection algorithm may be understood as a preset algorithm for detecting the feature information of a plurality of parts of the target object. The preset feature detection algorithm may implement the feature detection of the target object according to the change of the key points of the face or limb of the target object. Optionally, the preset feature detection algorithm may include a preset face feature detection algorithm and a preset limb feature detection algorithm, etc.

For example, the preset event information may be matched with a plurality of parts of the target object, and the parts corresponding to the event information may be used as the preset detection parts of the target object, for example, a plurality of key points of the face features or the limb and trunk such as the hand, the leg and the shoulder. Based on the preset feature detection algorithm, a plurality of key points of a plurality of parts of the face and the limb trunk are identified, and the change of the key points are determined, so that the event information triggered by the target object in the current image to be processed may be determined according to the key point information. For example, when it is detected that the target object is waving right hand, it may be determined that the event information triggered by the target object is waving, etc.

In the embodiment, determining whether to trigger event information may be achieved based on at least two implementations. The implementations may be described in the following.

The first implementation is that, determining the event information triggered by the target object in the current image to be processed based on a preset feature detection algorithm includes: determining current key point coordinate information of a plurality of preset detection parts of the target object based on the preset feature detection algorithm; for a same preset detection part, determining movement information of a current preset detection part based on the key point coordinate information and historical key point coordinate information of the preset detection part corresponding to the same preset detection part in a historical image to be processed before the current image to be processed; determining the event information triggered by the target object based on the movement information of the plurality of preset detection parts.

The preset detection part may be referred to the above expression. The historical image to be processed may be the image before the current image to be processed at the image collection moment. One or more frames of historical images to be processed before the current image to be processed may be determined according to the shooting time stamp of the image to be processed or the time stamp of playing a plurality of video frames.

The movement information may be determined according to the position information of the preset detection part in two adjacent images to be processed. Optionally, a point in the palm of the preset detection part is used as a reference point, and the position information of the reference point in two adjacent images to be processed is determined, and the position offset is determined according to the formula of the distance between two points, and the position offset is used as the movement information. If the movement information meets the preset condition, optionally the preset condition is the movement distance, then it is determined that the target object in the image to be processed triggers the event information. This setting may detect the movement information of the preset detection part according to the preset feature detection algorithm, so that the event information triggered by the target object may be determined according to the pre-stored trigger conditions.

The second implementation is that, determining the event information triggered by the target object in the current image to be processed based on a preset feature detection algorithm includes: determining current coordinate information of a plurality of preset detection parts in the target object based on the preset feature detection algorithm; determining the event information triggered by the target object based on current coordinate information of the plurality of preset detection parts and preset coordinate range information corresponding to the plurality of preset detection parts respectively.

In practical application, the waving action has a certain waving amplitude, and two extreme position information may be determined when waving, and the region between the extreme position information is used as the preset region. Accordingly, a plurality of coordinates in the preset region are all within the preset coordinate range, so at this time, the preset trigger range may be vectors corresponding to two extreme positions, which are the starting position and the ending position of the preset coordinate range.

For example, determining whether the current coordinate information of a plurality of preset detection positions is located in the preset coordinate range information corresponding to the plurality of preset detection positions may be performed according to the key point coordinate information of the preset detection positions. For example, five fingertips of the hand may be used as five key points, and the five key points may be connected with the key point of the palm respectively. According to the connection between the finger and the palm, it may be determined whether the hand of the target object is located in the preset coordinate range. If the current coordinate information of the plurality of preset detection positions all has preset coordinate range information corresponding to the plurality of preset detection positions respectively, the event information triggered by the target object may be determined. This setting may determine whether the target object triggers the event information according to the preset trigger range, which makes the trigger detection more sensitive. When the preset detection part of the target object is detected to be located in the preset trigger range, the corresponding event information may be triggered.

S230: determining part parameters of at least one model part in a target animation model according to body part information of the target object in the current image to be processed.

S240: determining target effect display parameters of the target animation model based on the part parameters and the event information.

S250: fusing a target face image of the target object into the target animation model and determining a target video frame corresponding to the current image to be processed and playing the target video frame based on the target effect display parameters.

According to the technical solution of the embodiment of the disclosure, by responding to the effect triggering operation, the current image to be processed including the target object and collected by the camera apparatus is acquired, the event information triggered by the target object in the current image to be processed is determined based on a preset feature detection algorithm, and the part parameters of the at least one model part in the target animation model are determined according to the body part information of the target object in the current image to be processed, the target effect display parameter of the target animation model is determined based on the part parameters and the event information, the target face image of the target object is fused into the target animation model, the target video frame corresponding to the current image to be processed is determined and displayed based on the target effect display parameters. The key point information of the plurality of parts in the target object may be detected by the preset feature detection algorithm, and corresponding event information may be determined according to the key point change information. Therefore, the animation effect corresponding to the event information may be determined according to the event information, and the animation effect may be played on the basis of the original animation effect, so that the target object and the target animation model are adapted to each other, which improves the user experience.

### Embodiment 3

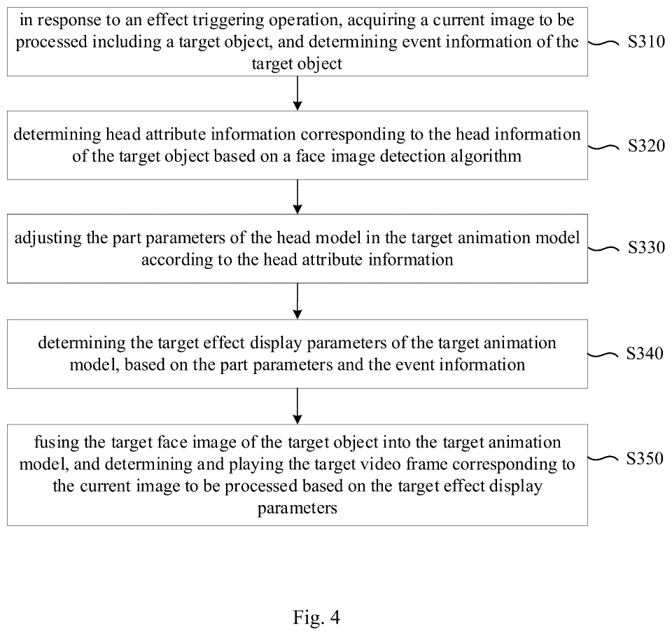

FIG. 4 is a flow chart of a video image processing method provided by Embodiment 3 of the present disclosure. On the basis of the aforementioned embodiment, S120 is described, and the implementation may refer to the technical solution of the embodiment. Among them, technical terms that are the same as or corresponding to the above embodiments are not repeated here.

As shown in FIG. 4, the method includes the following steps.

S310: in response to an effect triggering operation, acquiring a current image to be processed including a target object, and determining event information of the target object.

S320: determining head attribute information corresponding to the head information of the target object based on a face image detection algorithm.

The face image detection algorithm is the algorithm used to determine the user head information. The head attribute information includes head deflection angle information and position information.

In the embodiment, determining the head attribute information may be: determining whether the connecting line of the middle between eyebrows, the nose tip and the lip peak of the user is perpendicular to the horizontal plane. If it is vertical, it means the deflection angle is 0; otherwise, the relative deflection angle between the connecting line and the preset vertical line may be determined, and the relative deflection angle may be used as the head deflection angle. Another determining way may be to establish a world coordinate system with the nose tip as the coordinate origin and the vertical line between the nose tip and the middle between the eyebrows as the Z axis. Based on the shot face image and the world coordinate system, the head deflection angle is determined. For example, the three-dimensional coordinate information of the head center point is determined, and the deflection angle between the coordinate origin and the three-dimensional coordinate information is determined by using cosine similarity algorithm. The head position may be determined three-dimensional coordinate information.

The head attribute information further includes head depth information.

The head depth information is used to characterize the display proportion of the face image in the display interface. The depth information of the head may be that the image to be processed is converted into a depth map, and the gray value corresponding to the face region in the depth map is determined, and the obtained gray average value is used as the head attribute information. The depth information value is greater, it means the display size of the face image in the display interface is smaller, and conversely, the display size of the face image in the display interface is greater.

The presentation of the face image in the display interface may be that the face image is displayed in the head region of the target animation model in paster, that is, before the face image is pasted on the target animation model, the head of the target animation model is empty.

S330: adjusting the part parameters of the head model in the target animation model according to the head attribute information.

The part parameters of the head model in the target animation model are determined according to the head attribute information of the target object. Accordingly, according to the head attribute information of the target object, the part parameters of the head model in the target animation model are adjusted, so that the face image of the target object may be accurately displayed in the head model in the target animation model.

The part parameters of the head model may be understood as parameter information used to reflect the head movement in the target animation model. The part parameters include the deflection parameter and the movement parameter of the head model.

On the basis of the above technical solution, in order to make a plurality of key points of the limb and trunk in the target animation model being adaptive to the key points in the actual situation, or to make the target animation model show a more realistic display result, based on this, the measures that may be adopted are as follows: (1) processing the part parameters based on the inverse kinematics algorithm, determining the part parameters of other model parts to be determined in the target animation model other than the head model; wherein the model parts to be determined is matched with the limb and trunk of the target animation model.

Inverse Kinematics (IK) algorithm may be understood as an animation modeling method by driving the father node through the child node. The implementation of the algorithm may be as follows: according to the model parameters of the head model, adjusting the deflection information of a plurality of key points of bone below the head model in turn, and deflecting the corresponding key points in the model according to the determined deflection information, so as to implement the result of the smooth transition between the head and the spine. Correspondingly, the plurality of key point of bone below that head model may be used as a plurality of other model parts to be determined. The model parts to be determined may be the neck, the shoulder, the hand, the crotch and the leg etc. in turn.

S340: determining the target effect display parameters of the target animation model, based on the part parameters and the event information.

Determining the target effect display parameters may be as follows: determining a target animation effect to be fused consistent with the event information according to a pre-established effect mapping relationship table; determining the target effect display parameters based on the part parameters and the target animation effect to be fused.

The corresponding relationship between the event information and the animation effect to be fused corresponding to the event information may be pre-established, and the corresponding effect mapping relationship table may be established according to the corresponding relationship. The effect mapping table may include event information and corresponding animation effect to be fused. The animation effect to be fused may be superimposed animation effect corresponding to the event information. When the event information triggered by the target object is determined, the animation effect to be fused corresponding to the event information may be quickly determined according to the effect mapping relationship table, so that the display parameters of the target effect may be finally determined.

The corresponding relationship between different event information and animation effect to be fused corresponding to different event information may be pre-established. For example, when the event information is waving, the animation effect to be fused corresponding to the event information is that the hand in the target animation model is in the waving state.

The event information may also include the intensity information of animation effect to be fused corresponding to different trigger parameters when the target object triggers the event information. Based on this, the event information may be divided into various types of event information, such as event 1, event 2, . . . , event n, etc. Continuing the above example, when the event information is waving, when the waving amplitude is within the range of 5 degrees, the intensity of the animation effect to be fused corresponding to the event information is the first intensity, and when the waving amplitude is within the range of 10 degrees, the intensity of the animation effect to be fused is the second intensity. Then, for the same event information, the content of the superimposed animation effect to be fused is the same, but the intensity information of the animation effect will change.

In implementing, the target animation effect to be fused corresponding to the event information triggered by the target object may be determined according to the pre-established effect mapping relationship table, and the parameter information to be moved by the at least one model part in the target animation model and the effect parameter information corresponding to the target animation effect to be fused may be determined according to the part parameters of the target animation model and the determined target animation effect to be fused.

S350: fusing the target face image of the target object into the target animation model and determining and playing the target video frame corresponding to the current image to be processed based on the target effect display parameters.

According to the technical solution of the embodiment of the disclosure, by responding to the effect triggering operation, the current image to be processed including the target object is acquired and the event information of the target object is determined, and the head attribute information of the target object to be processed in the current image is determined based on the face image detection algorithm, and then the part parameters of the head model in the target animation model are adjusted according to the head attribute information, the target effect display parameters of the target animation model is determined, the target face image of the target object is fused into the target animation model, and the target video frame corresponding to the current image to be processed is determined and played based on the target effect display parameters, so that the target object and the target animation model are adapted to each other, so as to have a more vivid animation effect.

### Embodiment 4

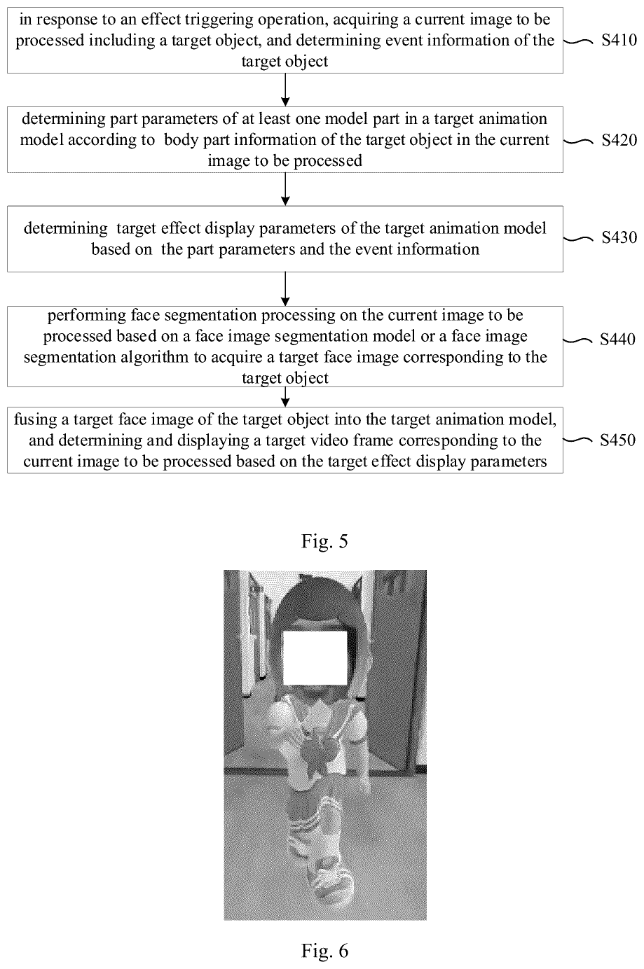

FIG. 5 is a flow chart of a video image processing method provided by Embodiment 4 of the present disclosure. On the basis of the above-mentioned embodiment, fusing the target face image of the target object into the head model in the target animation model may be implemented by adopting the technical solution disclosed in the embodiment. Among them, technical terms that are the same as or corresponding to the above embodiments are not repeated here.

As shown in FIG. 5, the method includes the following steps.

S410: in response to an effect triggering operation, acquiring a current image to be processed including a target object, and determining event information of the target object.

S420: determining part parameters of at least one model part in a target animation model according to body part information of the target object in the current image to be processed.

S430: determining target effect display parameters of the target animation model based on the part parameters and the event information.

S440: performing face segmentation processing on the current image to be processed based on a face image segmentation model or a face image segmentation algorithm to acquire a target face image corresponding to the target object.

The face image segmentation model may be understood as a neural network model pre-trained to implement face image segmentation. Optionally, the face image segmentation model may be composed of at least one of convolutional neural network, cyclic neural network and depth neural network, which is not limited by the embodiment of the present disclosure.

In the embodiment, the face image segmentation model may be acquired by training based on the sample images to be processed and the face region labeled images in the sample images to be processed. The training process of the face image segmentation model may be as follows: acquiring the sample image set to be processed, inputting the sample image set to the face image segmentation model to be trained to obtain an initial training result, and determining a loss result based on the initial training result and the face labeled images of the sample images to be processed, and generating a loss function, and adjusting the model parameters of the face image segmentation model to be trained based on the loss function until the training end condition is finally met, so as to obtain a trained face image segmentation model.

The face image segmentation algorithm may be understood as an algorithm for extracting face feature information and segmenting face feature information. For example, a process of segmenting the face image in the current image of the face image segmentation algorithm may be, graying the current image to be processed to obtain a target grayscale image, determining the edge contour in the target grayscale image according to the gray value in the target grayscale image, and determining the face region in the target grayscale image according to the edge contour. After determining the face region in the target grayscale image, the face region in the target grayscale image may be covered in the current image to be processed, so that the face region in the current image to be processed may be determined to obtain the target face image; or it may be extracting a variety of face feature information from the current image to be processed by the face image segmentation algorithm, for example extracting feature information which may clearly represent the face, such as the eye, the forehead, the nose and the mouth, and fusing the extracted feature information to obtain a face feature fusion result, and then segmenting the face image in the current image to be processed based on the face feature fusion result to obtain the target face image.

In the embodiment, the face image in the current image to be processed may be segmented based on the face image segmentation model or the face image segmentation algorithm, to obtain the target face image corresponding to the target object, so that the target face image may be fused with the head model of the target animation model, so that the target object and the target animation model are adapted to each other.

S450: fusing a target face image of the target object into the target animation model and determining and playing a target video frame corresponding to the current image to be processed based on the target effect display parameters.

In the embodiment, determining and playing a target video frame corresponding to the current image to be processed based on the target effect display parameters includes: adjusting a plurality of limbs and trunk in the target animation model based on the target effect display parameters to obtain the target video frame and play the target video frame.

In the embodiment, after acquiring the target face image, the target face image may be fused into the head model in the target animation model, so that the target object and the target animation model may be matched to each other, and based on the movement parameters of the plurality of the limbs and trunk in the target effect display parameters, the plurality of limbs and trunk in the target animation model are adjusted, so that the plurality of limbs and trunk of the target animation model may change correspondingly with the change of the head position, and the target video frame corresponding to the current image to be processed may be obtained and the target video frame is played. The schematic diagram of the display result of the target video frame corresponding to the current image to be processed may be referred in FIG. 6. In FIG. 6, the user face image and the head model of the target animation model are fused to each other, and the plurality of limbs and trunk of the target animation model make running movements.

According to the technical solution of the embodiment of the disclosure, by responding to the effect triggering operation, the current image to be processed including the target object is obtained, and the event information of the target object is determined; the part parameters of the at least one model part in the target animation model are determined according to the body part information of the target object in the current image to be processed; and the target effect display parameters of the target animation model are determined based on the part parameters and the event information, based on the face image segmentation model or face image segmentation algorithm, the current image to be processed is subjected to face segmentation, and the target face image corresponding to the target object is acquired, the target face image is fused into the head model in the target animation model, and the target video frame corresponding to the current image to be processed is determined and played based on the target effect display parameters, which implements the result of adapting the face image of the target object to the head model of the target animation model.

### Embodiment 5

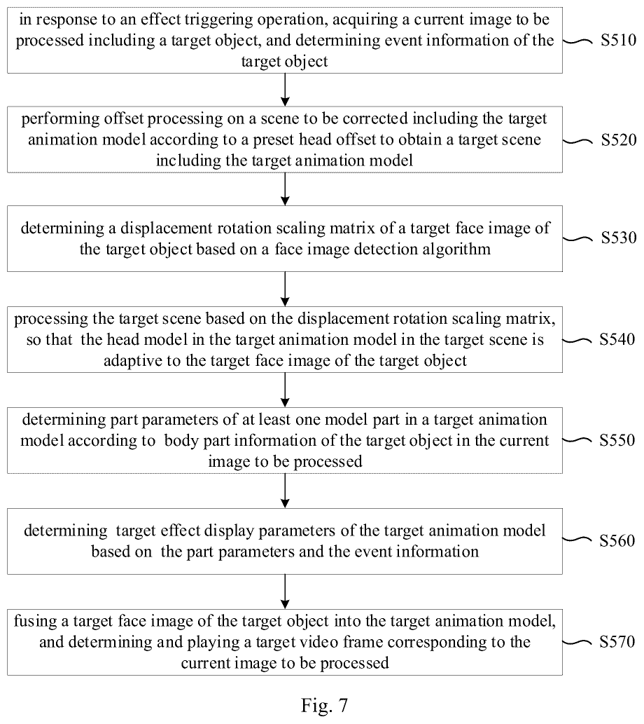

FIG. 7 is a flow chart of a video image processing method provided by Embodiment 5 of the present disclosure. On the basis of the aforementioned embodiment, the target face image of the target object is fused into the head model in the target animation model, which also may be implemented by adopting the technical solution disclosed in this embodiment. Among them, technical terms that are the same as or corresponding to the above embodiments are not repeated here.

As shown in FIG. 7, the method includes the following steps.

S510: in response to an effect triggering operation, acquiring a current image to be processed including a target object, and determining event information of the target object.

S520: performing offset processing on a scene to be corrected including the target animation model according to a preset head offset to obtain a target scene including the target animation model.

The scene to be corrected may be understood as the scene that needs to be corrected. The head offset may be understood as the head offset information of the target object. For example, a head offset range that may implement the offset process may be preset. When the head offset of the target object is in the preset offset range, the scene to be corrected may be subject to offset processing corresponding to the head offset, for example, the scene to be corrected moves up, down, left or right with the head of the target object.

In the embodiment, when the relative position of the head of the target object is detected to change, the scene that needs to be corrected including the target animation model may be subject to offset processing according to the preset head offset, so that the scene including the target animation model may be better adapted to the target object, and finally the target scene including the target animation model may be obtained.

S530: determining a displacement rotation scaling matrix of a target face image of the target object based on a face image detection algorithm.

The face image detection algorithm may be understood as an algorithm for detecting the face region in the image. The displacement rotation scaling matrix may be a transformation matrix obtained by combining three transformations in this order: scaling, rotation and translation. The expression of the displacement rotation scaling matrix may be expressed by the following formula:

$${M}_{translation} {M}_{rotation} {M}_{scal θ} = [ \begin{matrix}1 & 0 & 0 & {t}_{x} \\ 0 & 1 & 0 & {t}_{y} \\ 0 & 0 & 1 & {t}_{z} \\ 0 & 0 & 0 & 1\end{matrix} ] [ \begin{matrix}cos θ & 0 & sin θ & 0 \\ 0 & 1 & 0 & 0 \\ - sin θ & 0 & cos θ & 0 \\ 0 & 0 & 0 & 1\end{matrix} ] [ \begin{matrix}{k}_{x} & 0 & 0 & 0 \\ 0 & {k}_{y} & 0 & 0 \\ 0 & 0 & {k}_{z} & 0 \\ 0 & 0 & 0 & 1\end{matrix} ] = [ \begin{matrix}{k}_{x} cos θ & 0 & {k}_{z} sin θ & {t}_{x} \\ 0 & {k}_{y} & 0 & {t}_{y} \\ - {k}_{x} sin θ & 0 & {k}_{z} cos θ & - {t}_{z} \\ 0 & 0 & 0 & 0\end{matrix} ]$$

Among them, Mₜᵣₐₙₛₗₐₜᵢₒₙ represents a translation matrix; Mᵣₒₜₐₜᵢₒₙ represents a rotation matrix; M_{scalθ} represents a scaling matrix; tₓ represents the translation distance of any point on the X axis; t_{y} represents the translation distance of any point on the Y axis; t_{z} represents the translation distance of any point on the Z axis; θ represents the rotation angle; kₓ represents the scaling distance of any point on the X axis; k_{y} represents the scaling distance of any point on the Y axis; k_{z} represents the scaling distance of any point on the Z axis.

The displacement rotation scaling matrix may implement the relative position change of the target animation model in the transformation scene.

In the embodiment, the face key point information of the target object in the current image to be processed may be detected based on the face image detection algorithm, to determine the target face image of the target object and determine the displacement rotation scaling matrix of the target face image, so that the target animation model may be processed accordingly according to the matrix.

S540: processing the target scene based on the displacement rotation scaling matrix, so that the head model in the target animation model in the target scene is adaptive to the target face image of the target object.

In the embodiment, the target scene is processed according to the determined displacement rotation scaling matrix, so that the target animation model in the target scene may change according to the change of the target face image of the target object, to achieve the adaptation between them, so that a smoother effect display result may be achieved. The processing may be becoming larger or smaller based on the scaling matrix as a whole, or moving up or down as a whole, so that the target face image of the target object may be just placed in the head model in the target animation model.

S550: determining part parameters of at least one model part in a target animation model according to body part information of the target object in the current image to be processed.

S560: determining target effect display parameters of the target animation model based on the part parameters and the event information.

S570: fusing a target face image of the target object into the target animation model and determining and playing a target video frame corresponding to the current image to be processed.

According to the technical solution of the embodiment of the present disclosure, by responding to the effect triggering operation, the current image to be processed including the target object is acquired, and the event information of the target object is determined, and the scene to be corrected including the target animation model is subject to offset processing according to the preset head offset to obtain the target scene including the target animation model. For example, based on the face image detection algorithm, the displacement rotation scaling matrix of the target face image of the target object is determined, the target scene is processed based on the displacement rotation scaling matrix, so that the head model in the target animation model in the target scene is adaptive to the face image of the target object, the part parameters of at least one model part in the target animation model is determined according to the body part information of the target object in the current image to be processed, to determine the target effect display parameters in the target animation model based on the part parameters and the event information, the target face image of the target object is fused into the target animation model, and the target video frame corresponding to the current image to be processed is determined and played based on the display parameters of the target effect, so that the scene, the animation model and the target object are adapted and the playing result of the animation effect is effectively improved.

### Embodiment 6

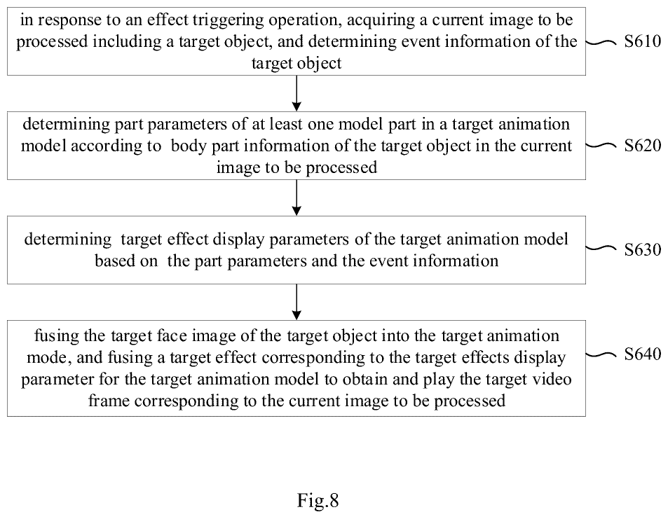

FIG. 8 is a flow chart of a video image processing method provided by Embodiment 6 of the present disclosure. On the basis of the aforementioned embodiment, S140 is described, and the implementation may refer to the technical solution of the embodiment. Among them, technical terms that are the same as or corresponding to the above embodiments are not repeated here.

As shown in FIG. 8, the method includes the following steps.

S610: in response to an effect triggering operation, acquiring a current image to be processed including a target object, and determining event information of the target object.

S620: determining part parameters of at least one model part in a target animation model according to body part information of the target object in the current image to be processed.

S630: determining target effect display parameters of the target animation model based on the part parameters and the event information.

S640: fusing the target face image of the target object into the target animation mode and fusing a target effect corresponding to the target effect display parameter for the target animation model to obtain and play the target video frame corresponding to the current image to be processed.

The target effect may be understood as the animation effect finally displayed by the target animation model in the display interface. Optionally, the target effects may include the limb and trunk display effect of the target animation model corresponding to the current limb parameters and part parameters, and the superimposed animation effect corresponding to the animation effect parameter to be fused. The animation effect needs to be matched with the limb and trunk model corresponding to animation effect.

The animation effect parameters to be fused may be understood as the animation effect parameters that need to be fused into the target animation model. The display effect of limb and trunk may be understood as the animation effect to be displayed by the limb and trunk of the target animation model. For example, the limb and trunk effect may include raising the hand, lifting the leg and twisting the body, etc. Accordingly, the animation effect corresponding to the animation effect parameters to be fused may be understood as superimposed animation effect determined based on the event information of the target object.

The animation effect is matched with the limb trunk and model corresponding to the animation effect, that is, the superimposed animation effect needs to cooperate with a plurality of limb and trunk models in the target animation model in order to achieve the best effect display result.

For example, the target effect corresponding to the target effect display parameters may be determined according to the determined target effect display parameters, and the target effect may be fused with the target animation model, that is, the target video frame image corresponding to the current image to be processed may be determined, and the target video frame image may be played. This setting may fuse the target effect into the target animation model and implement making the target animation model to interact with the target object, so that the target effect and the target object may be adapted to each other to achieve a more vivid effect display result.

On the basis of the above technical solution, in response to it is detected that the actual display duration of the fused animation corresponding to the event information reaches the preset display duration threshold, the fusion percentage of the fused animation is adjusted to a set value.

The actual display time may be understood as the time from the begin of the fused animation starting to fuse with the target animation model to the end of the fusion, that is, the playing time of the fused animation in the target video frame. The preset display duration threshold may be a preset duration range for judging whether the display duration of the fused animation meets the conditions. For example, the preset display duration threshold may be 5 seconds, 10 seconds or 15 seconds. The preset display duration threshold may be set manually, also may be set by the video image display system, or by other means, etc. Different fused animations may also correspond to different preset display duration thresholds, and the setting mode of the preset display duration threshold is not limited in the embodiment of the present disclosure. The fusion percentage may be understood as the display degree of the fused animation in the target animation model.

In the embodiment, when it is detected that the actual display duration of the fused animation corresponding to the event information reaches the preset display duration threshold, the fusion percentage of the fused animation may be adjusted to a set value, so that the fused animation is not displayed in the target animation model anymore. For example, the fused animation corresponding to “raising right hand” may be preset as “jump”, and the pre-display duration threshold may be set to 10 seconds. When it is detected that the animation display duration of the “jump” of the target animation model reaches 10 seconds, the fusion percentage of the “jump” animation may be adjusted to “0” so that the target animation model does not display the “jump” animation anymore. This setting may do not displaying the fusion effect after the effect fusion is completed or when the display duration of the fusion effect reaches the preset threshold, so that the target animation model may display other animation effect to be fused.

According to the technical solution of the embodiment of the disclosure, by responding to the effect triggering operation, the current image to be processed including the target object is acquired, and the event information of the target object is determined; the part parameters of the at least one model part in the target animation model are determined according to the body part information of the target object in the current image to be processed; and the target effect display parameters of the target animation model are determined based on the part parameters and the event information, the target face image of the target object is fused into the target animation model, and the target effect corresponding to the display parameters of the target effects is fused for the target animation model, finally, the target video frame corresponding to the image to be processed is obtained and played, which achieves the mutual adaptation between the target object and the target animation model, thus reaching a more vivid animation effect playing result.

### Embodiment 7

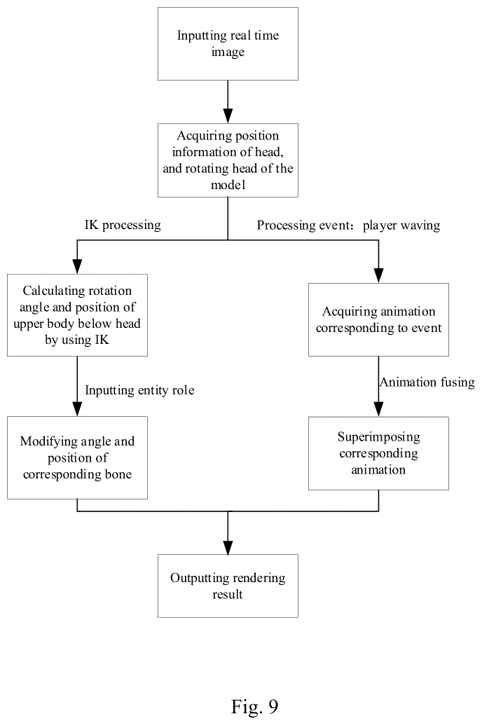

The embodiment is an optional embodiment of the above disclosed embodiments. FIG. 9 is a flowchart of a video image processing method provided by Embodiment 7 of the present disclosure. As shown in FIG. 9, the method of the embodiment of the present disclosure includes the following steps.

A real-time image (i.e., a current image to be processed) is input; position information (i.e., head attribute information) of a player is acquired, and the head of the target animation model is rotated; on the one hand, the event information triggered by the player (such as the player waving) is determined, the animation corresponding to the event information (that is, the animation effect to be fused) is acquired, the animation fusion is performed, and the animation corresponding to the event information is superimposed; on the other hand, based on the Inverse Kinematics (IK) algorithm, the head model parameters of the target animation model are processed, and the rotation angle and position of the upper body below the head in the target animation model (i.e., the part parameters of a plurality of model parts to be determined) are calculated, the player face image is fused into the head model in the model, and the angle and position of bone corresponding to the target animation model (i.e., a plurality of limbs and trunk of the target animation model) are modified; the superimposed target effect is fused for the target animation model, and the rendering result (that is, the target video frame) is output.

According to the technical solution of the embodiments of the present disclosure, by responding to the effect triggering operation, the current image to be processed including the target object is acquired, and the event information of the target object is determined; the part parameters of the at least one model part in the target animation model are determined according to the current image to be processed; and the target effect display parameters of the target animation model are determined based on the part parameters and the event information, the target video frame corresponding to the current image to be processed is determined and played based on the target effect display parameters, which enriches the prop for effect display. When the user uses the effect prop corresponding to the target animation model, the effect may be superimposed on the basis of the original effect, and a plurality of superimposed animation effects may be played simultaneously, which not only improves the richness and interest of video content, but also improves the playing result of animation effects.

### Embodiment 8

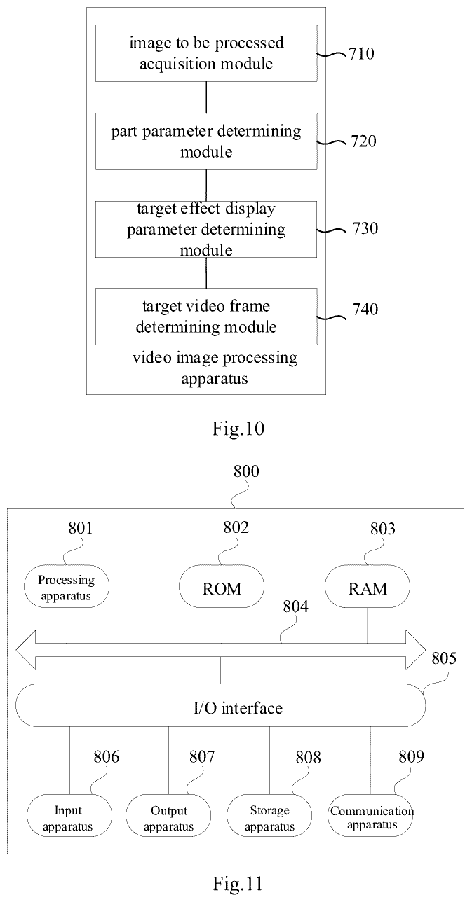

FIG. 10 is a structural block diagram of a video image processing apparatus provided by Embodiment 8 of the present disclosure, which may execute the video image processing method provided by any embodiment of the present disclosure and has corresponding functional modules and effects. As shown in FIG. 10, the apparatus includes an image acquisition module 710, a part parameter determining module 720, a target effect display parameter determining module 730 and a target video frame determining module 740.

The image to be processed acquisition module 710 is configured to acquire a current image to be processed including a target object and determine event information of the target object in response to an effect triggering operation; the part parameter determining module 720 is configured to determine part parameters of at least one model part in the target animation model according to body part information of the target object in the current image to be processed; the target effect display parameter determining module 730 is configured to determine target effect display parameters of the target animation model based on the part parameters and the event information; the target video frame determining module 740 is configured to fuse a target face image of the target object into the target animation model, and determine a target video frame corresponding to the current image to be processed and play the target video frame based on the target effect display parameters.

Based on the above plurality of technical solutions, the image acquisition module 710 includes a current image to be processed acquisition unit and an event information determining unit.

The current image to be processed acquisition unit is configured to acquire the current image to be processed including the target object and collected based on a camera apparatus;

The event information determining unit is configured to determine the event information triggered by the target object in the current image to be processed based on a preset feature detection algorithm.

Based on the above plurality of technical solutions, the event information determining unit includes a key point coordinate information determining subunit, a movement information determining subunit and an event information determining first subunit.

The key point coordinate information determining subunit is configured to determine current key point coordinate information of a plurality of preset detection parts of the target object based on the preset feature detection algorithm;

The movement information determining subunit is configured to for a same preset detection part, determine movement information of a current preset detection part based on the key point coordinate information and historical key point coordinate information of the preset detection part corresponding to the same preset detection part in a historical image before the current image to be processed;

The event information determining first subunit is configured to determine the event information triggered by the target object based on the movement information of the plurality of preset detection parts.

Based on the above plurality of technical solutions, the event information determining unit further includes a current coordinate information determining subunit and an event information determining second subunit.

The current coordinate information determining subunit is configured to determine current coordinate information of a plurality of preset detection parts in the target object based on the preset feature detection algorithm;

The event information determining second subunit configured to determine the event information triggered by the target object based on current coordinate information of the plurality of preset detection parts and preset coordinate range information corresponding to the plurality of preset detection parts respectively.

Based on the above plurality of technical solutions, the image acquisition module 710 includes an effect triggering operation setting unit.

The effect triggering operation setting unit is configured to trigger an effect prop corresponding to the target animation model; encompassing a face image in a detected view field region.

Based on the above plurality of technical solutions, the event information is matched with limb action information of a plurality of preset detection parts.

Based on the above plurality of technical solutions, the body part information includes head information, and the part parameter determining module 720 includes a head attribute information determining unit and a part parameter determining first unit.

The head attribute information determining unit is configured to determine head attribute information corresponding to the head information of the target object based on a face image detection algorithm, wherein the head attribute information includes head deflection angle information and head position information;

The part parameter determining first unit is configured to adjust the part parameters of the head model in the target animation model according to the head attribute information, wherein the part parameter includes a deflection parameter and a movement parameter of the head model.

Based on the above plurality of technical solutions, the part parameter determining module 720 further includes a part parameter determining second unit.

The part parameter determining second unit is configured to process the part parameters based on an inverse kinematics algorithm and determine the part parameters of a plurality of other model parts to be determined in the target animation model other than the head model; wherein the model parts to be determined is matched with a limb and trunk of the target animation model.

Based on the above plurality of technical solutions, the target effect display parameter determining module 730 includes a target animation effect determining unit and a target effect display parameter determining unit.

The target animation effect determining unit is configured to determine a target animation effect to be fused consistent with the event information according to a pre-established effect mapping relationship table, wherein the effect mapping relationship table includes the event information and animation effects to be fused corresponding to the event information;

The target effect display parameter determining unit is configured to determine the target effect display parameters based on the part parameters and the target animation effect to be fused.

Based on the above plurality of technical solutions, before the determining part parameters of at least one model part in a target animation model according to body part information of the target object in the current image to be processed, the apparatus further includes a scene processing module to be corrected.

The scene to be corrected processing module is configured to perform offset processing on a scene to be corrected including the target animation model according to a preset head offset to obtain a target scene including the target animation model.

Based on the above plurality of technical solutions, the target video frame determining module 740 is further configured to perform face segmentation processing on the current image to be processed based on a face image segmentation model or a face image segmentation algorithm to acquire a target face image corresponding to the target object; fuse the target face image into a head model in the target animation model.

Based on the above plurality of technical solutions, the target video frame determining module 740 is further configured to adjust a plurality of limbs and trunk in the target animation model based on the target effect display parameters to obtain the target video frame and play the target video frame.

Based on the above plurality of technical solutions, before determining the part parameters of the at least one model part in the target animation model according to the body part information of the target object in the image to be processed, the apparatus further includes a matrix determining module and a target scene processing module.

The matrix determining module configured to determine a displacement rotation scaling matrix of a target face image of the target object based on a face image detection algorithm.

The target scene processing module is configured to process the target scene based on the displacement rotation scaling matrix, so that the head model in the target animation model in the target scene is adaptive to the target face image of the target object.

Based on the above plurality of technical solutions, the target video frame determining module 740 further includes a target effect fusion unit.

The target effect fusion unit, configured to fuse a target effect corresponding to the target effect display parameter for the target animation model to obtain the target video frame corresponding to the current image to be processed and playing the target video frame.

Based on the above plurality of technical solutions, the target effect display parameters include a current limb parameter, the part parameters and the animation effect parameters to be fused corresponding to the event information of each limb and trunk model in the target animation model; the target effect includes a limb and trunk display effect of the target animation model corresponding to the current limb parameter and the part parameters, and the superimposed animation effect corresponding to the animation effect parameter to be fused; the animation effect is matched with the limb and trunk model corresponding to the animation effect.

Based on the above plurality of technical solutions, the apparatus further includes a fusion percentage adjustment module.

The fusion percentage adjustment module is configured to in response to detecting that an actual display duration of a fused animation corresponding to the event information reaches a preset display duration threshold, a fusion percentage of the fused animation is adjusted to a set value.

According to the technical solution of the embodiment of the present disclosure, by responding to the effect triggering operation, the current image to be processed including the target object is acquired, and the event information of the target object is determined; the part parameters of the at least one model part in the target animation model are determined according to the body part information of the target object in the current image to be processed; and the target effect display parameters of the target animation model are determined based on the part parameters and the event information, the target face image of the target object is fused into the target animation model, and the target video frame corresponding to the current image to be processed is determined and played based on the target effect display parameters, which enriches the prop for effect display. When the user uses the effect prop corresponding to the target animation model, the effect may be superimposed on the basis of the original effect, and a plurality of superimposed animation effects may be played simultaneously, which not only improves the richness and interest of video content, but also improves the playing result of animation effects.

The video image processing apparatus provided by the embodiment of the present disclosure may execute the video image processing method provided by any embodiment of the present disclosure and has corresponding functional modules and effects of the video image processing method.

A plurality of units and modules included in the above apparatus are only divided according to functional logic, but are not limited to the above division, provided that the corresponding functions can be achieved; in addition, names of a plurality of functional units are only for the convenience of distinguishing each other and are not used to limit the protection scope of the embodiment of the present disclosure.

### Embodiment 9

FIG. 11 is a schematic structural diagram of an electronic device provided in Embodiment 9 of the present disclosure. Referring to FIG. 11, FIG. 11 illustrates a schematic structural diagram of an electronic device (e.g., a terminal device or a server in FIG. 11) 800 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 11 is merely an example and should not pose any limitation to the functions and the range of use of the embodiments of the present disclosure.

As illustrated in FIG. 11, the electronic device 800 may include a processing apparatus 801 (e.g., a central processing unit, a graphics processing unit, etc.), which can perform various suitable actions and processing according to a program stored in a read-only memory (ROM) 802 or a program loaded from a storage apparatus 808 into a random-access memory (RAM) 803. The RAM 803 further stores various programs and data required for operations of the electronic device 800. The processing apparatus 801, the ROM 802, and the RAM 803 are interconnected by means of a bus 804. An input/output (I/O) interface 805 is also connected to the bus 804.

The following apparatus may be connected to the I/O interface 805: an input apparatus 806 including, for example, a touch screen, a touch pad, a keyboard, a mouse, a camera, a microphone, an accelerometer, a gyroscope, or the like; an output apparatus 807 including, for example, a liquid crystal display (LCD), a loudspeaker, a vibrator, or the like; a storage apparatus 808 including, for example, a magnetic tape, a hard disk, or the like; and a communication apparatus 809. The communication apparatus 809 may allow the electronic device 800 to be in wireless or wired communication with other devices to exchange data. While FIG. 11 illustrates the electronic device 800 having various apparatuses, not all of the illustrated apparatuses are necessarily implemented or included. More or fewer apparatuses may be implemented or included alternatively.

According to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 809 and installed, or may be installed from the storage apparatus 808, or may be installed from the ROM 802. When the computer program is executed by the processing apparatus 801, the above-mentioned functions defined in the methods of some embodiments of the present disclosure are performed.

Names of messages or information exchanged among multiple apparatuses in the embodiment of the present disclosure are only used for illustrative purposes and are not used to limit the scope of these messages or information.

The electronic device provided by the embodiment of this disclosure belongs to the same concept as the video image processing method provided by the above embodiments, and the technical details not described in detail in this embodiment may be found in the above embodiments, and this embodiment has the same effect as the above embodiments.

### Embodiment 10

An embodiment of the present disclosure provides a computer storage medium on which a computer program is stored. When the computer program is executed by a processor, the video image processing method provided in the above embodiment is implemented.

The above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a RAM, a ROM, an erasable programmable read-only memory (EPROM), a flash memory, an optical fiber, a portable compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

In some implementation modes, the client and the server may communicate with any network protocol currently known or to be researched and developed in the future such as hypertext transfer protocol (HTTP) and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device or may also exist alone without being assembled into the electronic device.

The computer-readable medium carries one or more programs. The one or more programs, when executed by the electronic device, cause the electronic device to:
in response to an effect triggering operation, acquire a current image to be processed including a target object, and determine event information of the target object;
determine part parameters of at least one model part in a target animation model according to body part information of the target object in the current image to be processed;
determine target effect display parameters of the target animation model based on the part parameters and the event information;
fuse a target face image of the target object into the target animation model and determine a target video frame corresponding to the current image to be processed and play the target video frame based on the target effect display parameters.

The computer program code for executing the operation of the present disclosure may be written in one or more programming languages or combinations thereof, the above programming language includes but is not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including LAN or WAN, or may be connected to an external computer (such as connected by using an internet service provider through the Internet).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. In some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. Each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the first acquisition unit may also be described as “the unit that acquires at least two Internet protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, RAM, ROM, EPROM, flash memory, optical fiber, portable CD-ROM, optical storage device, magnetic storage device, or any suitable combination of the foregoing. The storage medium can be a non-transitory storage medium.

According to one or more embodiments of the present disclosure, [Example 1] provides a video image processing method, including:
in response to an effect triggering operation, acquiring a current image to be processed including a target object, and determining event information of the target object;
determining part parameters of at least one model part in a target animation model according to body part information of the target object in the current image to be processed;
determining target effect display parameters of the target animation model based on the part parameters and the event information;
fusing a target face image of the target object into the target animation model and determining a target video frame corresponding to the current image to be processed and playing the target video frame based on the target effect display parameters.

According to one or more embodiments of the present disclosure, [Example 2] provides a video image processing method, further including:
optionally, the acquiring a current image to be processed including a target object, and determining event information of the target object includes:
acquiring the current image to be processed including the target object and collected based on a camera apparatus;
determining the event information triggered by the target object in the current image to be processed based on a preset feature detection algorithm.

According to one or more embodiments of the present disclosure, [Example 3] provides a video image processing method, further including:
optionally, the determining the event information triggered by the target object in the current image to be processed based on a preset feature detection algorithm includes:
determining current key point coordinate information of a plurality of preset detection parts of the target object based on the preset feature detection algorithm;
for a same preset detection part, determining movement information of a current preset detection part based on the key point coordinate information and historical key point coordinate information of the preset detection part corresponding to the same preset detection part in a historical image before the current image to be processed;
determining the event information triggered by the target object based on the movement information of the plurality of preset detection parts.

According to one or more embodiments of the present disclosure, [Example 4] provides a video image processing method, further including:
optionally, the determining the event information triggered by the target object in the current image to be processed based on a preset feature detection algorithm includes:
determining current coordinate information of a plurality of preset detection parts in the target object based on the preset feature detection algorithm;
determining the event information triggered by the target object based on current coordinate information of the plurality of preset detection parts and preset coordinate range information corresponding to the plurality of preset detection parts respectively.

According to one or more embodiments of the present disclosure, [Example 5] provides a video image processing method, further including:
optionally, the effect triggering operation includes at least one of the following:
triggering an effect prop corresponding to the target animation model;
encompassing a face image in a detected view field region.

According to one or more embodiments of the present disclosure, [Example 6] provides a video image processing method, further including:
optionally, the event information is matched with limb action information of a plurality of preset detection parts.

According to one or more embodiments of the present disclosure, [Example 7] provides a video image processing method, further including:
optionally, the body part information includes head information, and the determining part parameters of at least one model part in a target animation model according to body part information of the target object in the current image to be processed includes:
determining head attribute information corresponding to the head information of the target object based on a face image detection algorithm, wherein the head attribute information includes head deflection angle information and head position information;
adjusting the part parameters of the head model in the target animation model according to the head attribute information, wherein the part parameter includes a deflection parameter and a movement parameter of the head model.

According to one or more embodiments of the present disclosure, [Example 8] provides a video image processing method, further including:
optionally, processing the part parameters based on an inverse kinematics algorithm, and determining the part parameters of a plurality of other model parts to be determined in the target animation model other than the head model; wherein the model parts to be determined is matched with a limb and trunk of the target animation model.

According to one or more embodiments of the present disclosure, [Example 9] provides a video image processing method, further including:
optionally, the determining target effect display parameters of the target animation model based on part parameters and the event information includes:
determining a target animation effect to be fused consistent with the event information according to a pre-established effect mapping relationship table, wherein the effect mapping relationship table includes the event information and animation effects to be fused corresponding to the event information;
determining the target effect display parameters based on the part parameters and the target animation effect to be fused.

According to one or more embodiments of the present disclosure, [Example 10] provides a video image processing method, further including:
optionally, before the determining part parameters of at least one model part in a target animation model according to body part information of the target object in the current image to be processed, the method further includes:
performing offset processing on a scene to be corrected including the target animation model according to a preset head offset to obtain a target scene including the target animation model.

According to one or more embodiments of the present disclosure, [Example 11] provides a video image processing method, further including:
optionally, the fusing a target face image of the target object into the target animation mode includes:
performing face segmentation processing on the current image to be processed based on a face image segmentation model or a face image segmentation algorithm to acquire a target face image corresponding to the target object;
fusing the target face image into a head model in the target animation model.

According to one or more embodiments of the present disclosure, [Example 12] provides a video image processing method, further including:
optionally, the determining a target video frame corresponding to the current image to be processed and playing the target video frame based on the target effect display parameters includes:
adjusting a plurality of limbs and trunk in the target animation model based on the target effect display parameters to obtain the target video frame and play the target video frame.

According to one or more embodiments of the present disclosure, [Example 13] provides a video image processing method, further including:
optionally, before the determining part parameters of at least one model part in a target animation model according to body part information of the target object in the current image to be processed, the method further includes:
determining a displacement rotation scaling matrix of a target face image of the target object based on a face image detection algorithm;
processing the target scene based on the displacement rotation scaling matrix, so that the head model in the target animation model in the target scene is adaptive to the target face image of the target object.

According to one or more embodiments of the present disclosure, [Example 14] provides a video image processing method, further including:
optionally, the determining a target video frame corresponding to the current image to be processed and playing the target video frame based on the target effect display parameters includes:
fusing a target effect corresponding to the target effect display parameter for the target animation model to obtain the target video frame corresponding to the current image to be processed and playing the target video frame.

According to one or more embodiments of the present disclosure, [Example 15] provides a video image processing method, further including:
optionally, the target effect display parameters includes a current limb parameter, the part parameters and the animation effect parameters to be fused corresponding to the event information of each limb and trunk model in the target animation model; the target effect includes a limb and trunk display effect of the target animation model corresponding to the current limb parameter and the part parameters, and the superimposed animation effect corresponding to the animation effect parameter to be fused; the animation effect is matched with the limb and trunk model corresponding to the animation effect.

According to one or more embodiments of the present disclosure, [Example 16] provides a video image processing method, further including:
optionally, in response to detecting that an actual display duration of a fused animation corresponding to the event information reaches a preset display duration threshold, a fusion percentage of the fused animation is adjusted to a set value.

According to one or more embodiments of the present disclosure, [Example 17] provides a video image processing apparatus, including:
an image to be processed acquisition module, configured to acquire a current image to be processed including a target object, and determine event information of the target object in response to an effect triggering operation;
a part parameter determining module, configured to determine part parameters of at least one model part in the target animation model according to body part information of the target object in the current image to be processed;
a target effect display parameter determining module configured to determine target effect display parameters of the target animation model based on the part parameters and the event information;
a target video frame determining module, configured to fuse a target face image of the target object into the target animation model, and determine a target video frame corresponding to the current image to be processed and play the target video frame based on the target effect display parameters.

The scope of the disclosure involved herein is not limited to the technical solutions formed by a specific combination of the technical features described above and shall cover other technical solutions formed by any combination of the technical features described above or equivalent features thereof without departing from the concept of the present disclosure. For example, the technical features described above may be mutually replaced with the technical features having similar functions disclosed herein to form technical solutions.

In addition, while a plurality of operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, the subject matter defined in the appended claims is not necessarily limited to the particular features and acts described above. Rather, the particular features and acts described above are merely exemplary forms for implementing the claims.

1. A video image processing method, comprising:
in response to an effect triggering operation, acquiring a current image to be processed comprising a target object, and determining event information of the target object;
determining part parameters of at least one model part in a target animation model according to body part information of the target object in the current image to be processed;
determining target effect display parameters of the target animation model based on the part parameters and the event information; and
fusing a target face image of the target object into the target animation model and determining a target video frame corresponding to the current image to be processed and playing the target video frame based on the target effect display parameters.

2. The method according to claim 1, wherein the acquiring a current image to be processed comprising a target object, and determining event information of the target object comprises:
acquiring the current image to be processed comprising the target object and collected based on a camera apparatus;
determining the event information triggered by the target object in the current image to be processed based on a preset feature detection algorithm.

3. The method according to claim 2, wherein the determining the event information triggered by the target object in the current image to be processed based on a preset feature detection algorithm comprises:
determining current key point coordinate information of a plurality of preset detection parts of the target object based on the preset feature detection algorithm;
for a same preset detection part, determining movement information of a current preset detection part based on the key point coordinate information and historical key point coordinate information of the preset detection part corresponding to the same preset detection part in a historical image before the current image to be processed;
determining the event information triggered by the target object based on the movement information of the plurality of preset detection parts.

4. The method according to claim 2, wherein the determining the event information triggered by the target object in the current image to be processed based on a preset feature detection algorithm comprises:
determining current coordinate information of a plurality of preset detection parts in the target object based on the preset feature detection algorithm;
determining the event information triggered by the target object based on current coordinate information of the plurality of preset detection parts and preset coordinate range information corresponding to the plurality of preset detection parts respectively.

5. The method according to claim 1, wherein the effect triggering operation comprises at least one of the following:
triggering an effect prop corresponding to the target animation model;
encompassing a face image in a detected view field region.

6. The method according to claim 1, wherein the event information is matched with limb action information of a plurality of preset detection parts.

7. The method according to claim 1, wherein the body part information comprises head information, and the determining part parameters of at least one model part in a target animation model according to body part information of the target object in the current image to be processed comprises:
determining head attribute information corresponding to the head information of the target object based on a face image detection algorithm, wherein the head attribute information comprises head deflection angle information and head position information;
adjusting the part parameters of the head model in the target animation model according to the head attribute information, wherein the part parameters comprise a deflection parameter and a movement parameter of the head model.

8. The method according to claim 7, further comprising:
processing the part parameters based on an inverse kinematics algorithm, and determining the part parameters of a plurality of other model parts to be determined in the target animation model other than the head model;
wherein the model parts to be determined is matched with a limb and trunk of the target animation model.

9. The method according to claim 1, wherein the determining target effect display parameters of the target animation model based on part parameters and the event information comprises:
determining a target animation effect to be fused consistent with the event information according to a pre-established effect mapping relationship table, wherein the effect mapping relationship table comprises the event information and animation effects to be fused corresponding to the event information;
determining the target effect display parameters based on the part parameters and the target animation effect to be fused.

10. The method according to claim 1, wherein before the determining part parameters of at least one model part in a target animation model according to body part information of the target object in the current image to be processed, the method further comprises:
performing offset processing on a scene to be corrected comprising the target animation model according to a preset head offset to obtain a target scene comprising the target animation model.

11. The method according to claim 1, wherein the fusing a target face image of the target object into the target animation mode comprises:
performing face segmentation processing on the current image to be processed based on a face image segmentation model or a face image segmentation algorithm to acquire a target face image corresponding to the target object;
fusing the target face image into a head model in the target animation model.

12. The method according to claim 11, wherein the determining a target video frame corresponding to the current image to be processed and playing the target video frame based on the target effect display parameters comprises:
adjusting a plurality of limbs and trunk in the target animation model based on the target effect display parameters to obtain the target video frame and play the target video frame.

13. The method according to claim 10, wherein before the determining part parameters of at least one model part in a target animation model according to body part information of the target object in the current image to be processed, the method further comprises:
determining a displacement rotation scaling matrix of a target face image of the target object based on a face image detection algorithm;
processing the target scene based on the displacement rotation scaling matrix, so that the head model in the target animation model in the target scene is adaptive to the target face image of the target object.

14. The method according to claim 1, wherein the determining a target video frame corresponding to the current image to be processed and playing the target video frame based on the target effect display parameters comprises:
fusing a target effect corresponding to the target effect display parameter for the target animation model to obtain the target video frame corresponding to the current image to be processed and playing the target video frame.

15. The method according to claim 14, wherein the target effect display parameters comprise a current limb parameter, the part parameters and the animation effect parameters to be fused corresponding to the event information of each limb and trunk model in the target animation model; the target effect comprises a limb and trunk display effect of the target animation model corresponding to the current limb parameter and the part parameters, and the superimposed animation effect corresponding to the animation effect parameter to be fused; the animation effect is matched with the limb and trunk model corresponding to the animation effect.

16. The method according to claim 15, further comprising:
in response to detecting that an actual display duration of a fused animation corresponding to the event information reaches a preset display duration threshold, a fusion percentage of the fused animation is adjusted to a set value.

17. (canceled)

18. An electronic device comprising:
at least one processor; and
at least one storage apparatus, configured to store at least one program,
when the at least one program is executed by the at least one processor, the at least one processor is caused to implement a video image processing method, which comprises:
in response to an effect triggering operation, acquiring a current image to be processed comprising a target object, and determining event information of the target object;
determining part parameters of at least one model part in a target animation model according to body part information of the target object in the current image to be processed;
determining target effect display parameters of the target animation model based on the part parameters and the event information; and
fusing a target face image of the target object into the target animation model and determining a target video frame corresponding to the current image to be processed and playing the target video frame based on the target effect display parameters.

19. A non-transient computer-readable storage medium containing computer-executable instructions, wherein the computer-executable instructions perform a video image processing method when the computer-executable instructions are executed by a computer processor, the video image processing method comprises:
in response to an effect triggering operation, acquiring a current image to be processed comprising a target object, and determining event information of the target object;
determining part parameters of at least one model part in a target animation model according to body part information of the target object in the current image to be processed;
determining target effect display parameters of the target animation model based on the part parameters and the event information; and
fusing a target face image of the target object into the target animation model and determining a target video frame corresponding to the current image to be processed and playing the target video frame based on the target effect display parameters.

20. The electronic device according to claim 18, wherein the acquiring a current image to be processed comprising a target object, and determining event information of the target object comprises:
acquiring the current image to be processed comprising the target object and collected based on a camera apparatus;
determining the event information triggered by the target object in the current image to be processed based on a preset feature detection algorithm.

21. The electronic device according to claim 20, wherein the determining the event information triggered by the target object in the current image to be processed based on a preset feature detection algorithm comprises:
determining current key point coordinate information of a plurality of preset detection parts of the target object based on the preset feature detection algorithm;
for a same preset detection part, determining movement information of a current preset detection part based on the key point coordinate information and historical key point coordinate information of the preset detection part corresponding to the same preset detection part in a historical image before the current image to be processed;
determining the event information triggered by the target object based on the movement information of the plurality of preset detection parts.
